(19) United States
(12) Patent Application Publication
(10) Pub. No.: US 2006/0214993 A1
(43) Pub. Date: Sep. 28, 2006

(54) Liquid ejection apparatus

(75) Inventor: Yuji Iwata, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/386,990

(22) Filed: Mar. 22, 2006

(30) Foreign Application Priority Data
Mar. 23, 2005 (JP) 2005-084585

(51) Int. Cl. B41J 2/14; B41J 2/015

(52) U.S. Cl. 347/52; 347/20; 347/51

(57) ABSTRACT

An ejection head 30 is formed in a carriage 29 as inclined at an ejection angle θ1. This permits a microdroplet Fb, which is ejected from the ejection head 30, to travel in an ejecting direction J1 that is inclined at the ejection angle θ1 with respect to a normal line of the substrate 2. Thus, the position at which the microdroplet Fb is received by a backside 2b of the substrate 2, or a receiving position Pa, is brought closer to a radiating position of a laser beam B, or located offset from a nozzle position PN toward the radiating position of the laser beam B, by a first offset amount L1. This adjusts the size of a dot formed by drying the microdroplet Fb to a desired size.

### BACKGROUND OF THE INVENTION

The present invention relates to liquid ejection apparatuses.

A typical electro-optic apparatus such as a liquid crystal displays and an organic electroluminescence display (organic EL display) includes a transparent glass substrate (hereinafter, “substrate”) for displaying images. Such a substrate includes an identification code (for example, a two-dimensional code) that indicates encoded information regarding the name of the manufacturer or the product number for the sake of quality control and production management. One such identification code includes a number of aligned data cells and a plurality of dots (formed by, for example, colored thin films or recesses). The dots are provided in selected ones of the data cells, thus representing the encoded information regarding the substrate.

As methods for forming the identification code, a laser sputtering method and a waterjet method have been proposed. In the laser sputtering method, a mark is formed through sputtering by radiating a laser beam on a metal foil. In the waterjet method, the mark is provided in the substrate by ejecting water containing abrasive onto the substrate. For detailed information, refer to Japanese Laid-Open Patent Publication Nos. 11-77340 and 2003-127537

However, in the laser sputtering method, in order to obtain a mark of a desired size, the distance between the foil and the substrate must be set to several to several tens of micrometers. Thus, the surfaces of the metal foil and the substrate must be formed extremely fiat and spaced from each other by a distance accurately adjusted in the order of micrometers. As a result, the laser sputtering method is applicable only to limited types of substrates, or cannot be used widely for general substrates. Further, in the waterjet method, water, dust, and abrasive is splashed onto the substrate when forming the mark. This may contaminate the substrate.

To solve these problems, an inkjet method is now focused on as an alternative method for forming the identification code. In the inkjet method, microdroplets of liquid containing metal particles are ejected by a liquid ejection apparatus. Each of the liquid droplets is then dried and thus defines a dot. The inkjet method is thus applicable to a wider range of substrates. Further, the identification code is formed without contaminating the substrate.

However, since formation of the dots by the inkjet method involves drying of each microdroplet on the substrate, the following problem may occur depending on the surface condition of the substrate or due to surface tension produced in the microdroplet.

More specifically, since each microdroplet is wet when received by the surface of the substrate, the microdroplet, or the dot, may spread beyond the original data cell and enter an adjacent data cell that is supposed to be empty. This makes it impossible to read the identification code accurately. The product information regarding the substrate is thus damaged.

This problem may be prevented if each microdroplet is quickly dried by radiating a laser beam onto the microdroplet immediately after the microdroplet has been received by the substrate.

However, as shown in FIG. 12, an ejection head 90, through which a microdroplet Fb of liquid F is ejected, normally includes a line 91 in which the liquid F flows, a cavity 92 that retains the liquid F, and pressurization means 93 that pressurizes the liquid F in the cavity 92. The ejection head 90 includes en ejection port 94 through which the microdroplet Fb is ejected. However, location of the ejection port 94 is limited to a position in the vicinity of the center of the ejection head 90 in order to facilitate the layout of the other components of the ejection head 90 and machining of the ejection head 90. Thus, the position at which the microdroplet Fb is received by the substrate (a receiving position Pa) is spaced from the position onto which a laser beam B is radiated by a laser head 96 (a radiating position Pb). This may cause. the micro droplet Fb to spread beyond the original data cell in a wet state while being transported from the receiving position Pa to the radiating position Pb. In this case, the microdroplet Fb may enter an adjacent cell and thus result in an overflowing dot.

### SUMMARY

Accordingly, it is an objective of the present invention to provide a liquid ejection apparatus capable of adjusting the size of a dot formed by drying a droplet of liquid to a desired size.

According to a first aspect of the invention, a liquid ejection apparatus having an ejection head and a laser radiation device is provided. The ejection head includes an ejection port through which a liquid droplet containing a dot forming material is ejected onto a substrate. The laser radiation device radiates a laser beam that dries the liquid droplet on the substrate and thus forms a dot from the dot forming material. In the liquid ejection apparatus, the ejection head is oriented in such a manner that the liquid droplet is ejected from the ejection port to a radiating position of the laser beam defined on the substrate.

According to a second aspect of the invention, an identification code formation apparatus for forming a dot-matrix identification code on a substrate is provided. The apparatus includes an ejection head, a laser radiation device, a transport device, and a controller. The ejection head has a plurality of ejection ports aligned in a direction X. Each of the ejection ports ejects a liquid droplet containing a dot forming material onto the substrate. The laser radiation device radiates a laser beam onto each of the liquid droplets received by the substrate so as to dry the liquid droplet and thus form dots from the dot forming material. The transport device transports the substrate in a direction Y crossing the direction in which the ejection ports are aligned. The controller controls the ejection head, the laser radiation device, and the transport device in such a manner as to sequentially perform ejection of the liquid droplets, radiation of the laser beam, and transport of the substrate. The ejection head is oriented in such a manner that each of the liquid droplets is ejected from the corresponding ejection port toward a radiating position of the laser beam defined on the substrate.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a liquid crystal display module;

FIG. 2 is a front view showing an identification code according to an embodiment of the present invention;

FIG. 3 is a side view showing the identification code and a substrate;

FIG. 4 is a view for explaining the configuration of the identification code;

FIG. 5 is a perspective view showing a main portion of a liquid ejection apparatus;

FIG. 6 is a schematic cross-sectional view for explaining the liquid ejection apparatus;

FIG. 7 is a schematic perspective view for explaining an ejection head and a laser head;

FIG. 8 is a cross-sectional view showing a main portion of the ejection head and that of the laser head for explaining operation of the heads;

FIG. 9 is a block circuit diagram representing the liquid ejection apparatus;

FIG. 10 is a timing chart representing the operational timing of a piezoelectric element and that of a semiconductor laser;

FIG. 11 is a cross-sectional view showing a main portion of an ejection head and that of a laser head of a modified embodiment for explaining operation of the heads; and

FIG. 12 is a cross-sectional view showing a main portion of a typical ejection head and that of a typical laser head for explaining operation of the heads.

### DETAILED DESCRIPTION OF THE PREFERRED EMBODIMENTS

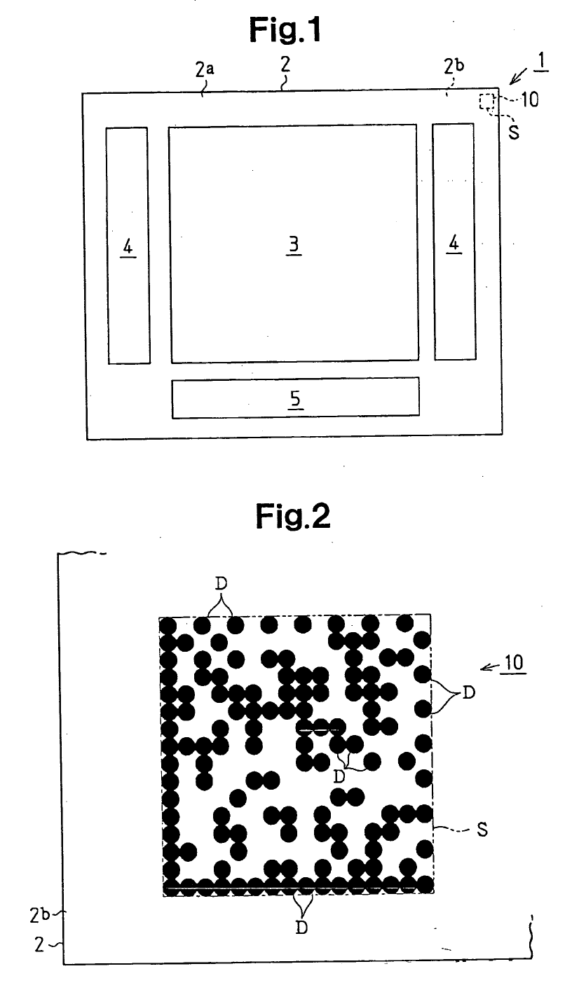

An apparatus for forming a dot-matrix identification code 10 on a substrate 2 according to an embodiment of the present invention will now be described with reference to FIGS. 1 to 10.

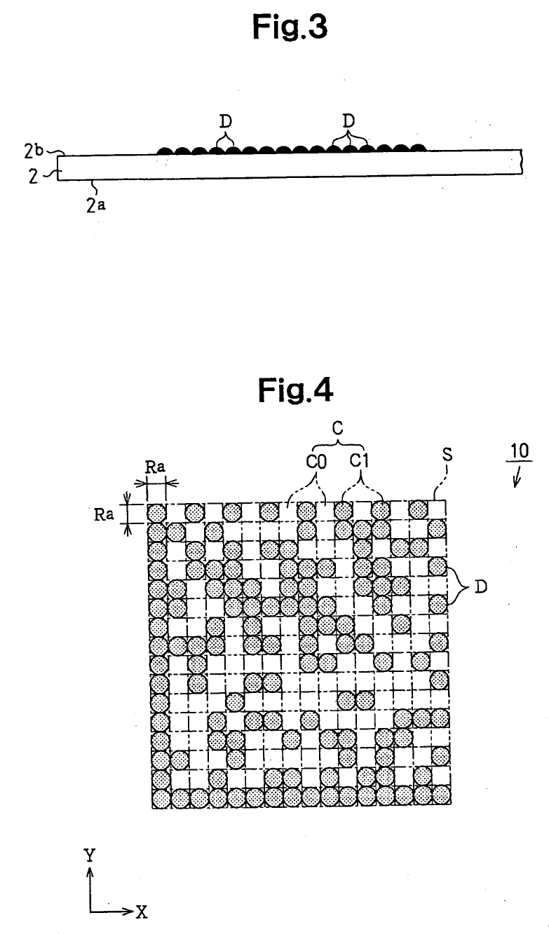

First, a display module of a liquid crystal display formed by a liquid ejection apparatus 20 according to the present invention will be explained. FIG. 1 is a front view showing a liquid crystal display module 1 of the liquid crystal display. FIG. 2 is a front view showing the liquid crystal display module 1 and the identification code 10. FIG. 3 is a side view showing the liquid crystal display module 1 and the identification code 10.

As shown in FIG. 1, the liquid crystal display module 1 includes a transparent glass substrate 2 (hereinafter, referred to as a substrate 2), or a light transmittable display substrate. A rectangular display portion 3 is formed substantially in a center of a surface 2a of the substrate 2. Liquid crystal molecules are sealed in the display portion 3. A scanning line driver circuit 4 and a data line driver circuit 5 are arranged outside the display portion 3. The scanning line driver circuit 4 generates scanning signals and the data line driver circuit 5 generates data signals. In correspondence with the signals, the liquid crystal display module 1 controls orientations of the liquid crystal molecules. The liquid crystal display module 1 modulates area light emitted by a non-illustrated illumination device in accordance with the orientation of the liquid crystal molecules. In this manner, a desired image is displayed on the display portion 3.

The identification code 10 of the liquid crystal display module 1 is formed on a backside 2b of the substrate 2. Specifically, the identification code 10 is formed in a top right corner of the backside 2b as viewed in the drawing. Referring to FIG. 2, the identification code 10 is formed by a plurality of matrix dots provided in a code formation area 5.

The code formation area S is hypothetically divided into 256 uniform data cells (hereinafter, cells C), which are arranged in accordance with 16 rows×16 columns. More specifically, the code formation area S is defined by a square area each side of which is 1.12 millimeter long. Each of the cells C is defined in a square shape each side of which is 70 micrometer long (the cell width Ra is 70 micrometers). A plurality of dots D are formed in selected ones of the cells C, thus providing the identification code 10 that identifies the product number or the lot number of the liquid crystal display module 1.

In the illustrated embodiment, the cells C in which the dots D are provided are referred to as black cells C1. The empty cells C are referred to as blank cells C0. With reference to FIG. 4, the rows of the cells C are numbered successively from upward to downward as a first row to a sixteenth row as viewed in the drawing. The columns of the cells C are numbered successively from the left to the right as a first column to a sixteenth column, as viewed in FIG. 4.

Each of the dots D, which is provided in the corresponding black cell C1, forms a semispherical shape and is tightly bonded with the substrate 2, as shown in FIGS. 2 and 3. The dots D are provided using an inkjet method.

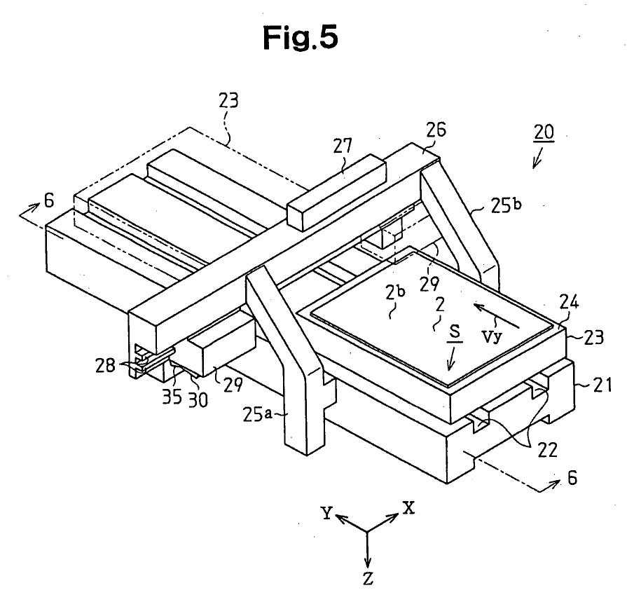

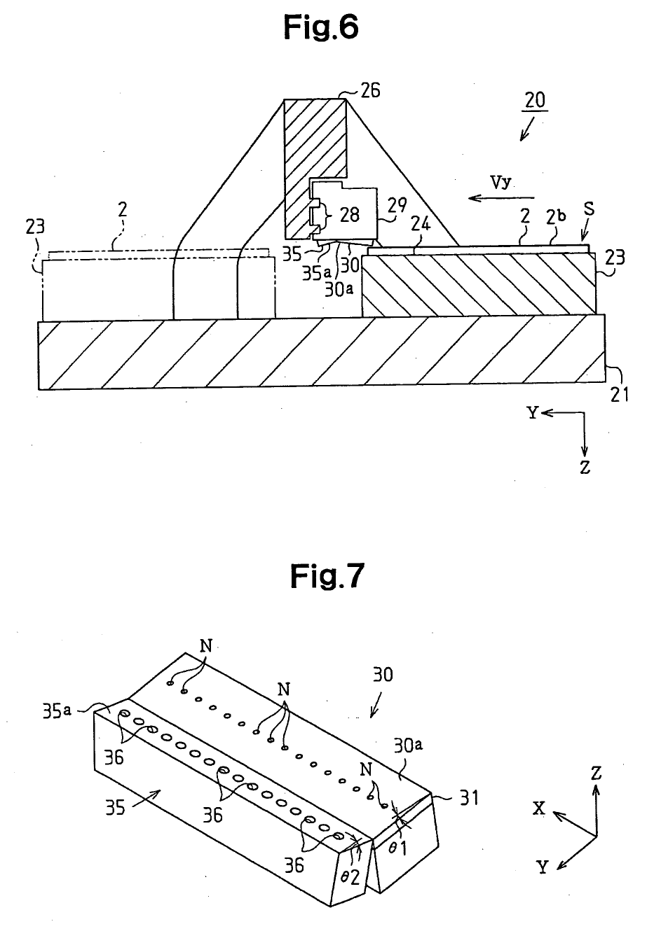

More specifically, the dots D are formed In the following manner. The liquid ejection apparatus 20, which is shown in FIGS. 5 and 6, includes ejection ports, or ejection nozzles N (hereinafter, nozzles N). A microdroplet Fb containing metal particles (for example, nickel particles) as a dot forming material is ejected onto a corresponding one of the cells C (the black cells C1) through each of the nozzles N. The microdroplet Fb is then dried in the cell C and thus the metal particles are sintered. More specifically, each microdroplet Fb is dried by radiating a laser beam onto the microdroplet Fb that has been received by the substrate 2 (the corresponding black cell C1).

The following is a detailed explanation of the liquid ejection apparatus 20, which forms the identification code 10 on the backside 2b of the substrate 2. FIG. 5 is a perspective view showing the structure of the liquid ejection apparatus 20. FIG. 6 is a schematic cross-sectional view taken along line 6-6 of FIG. 5.

As shown in FIG. 5, the liquid ejection apparatus 20 has a parallelepiped base 21. In the illustrated embodiment, the longitudinal direction of the base 21 is defined as direction Y and the direction perpendicular to direction Y is defined as direction X.

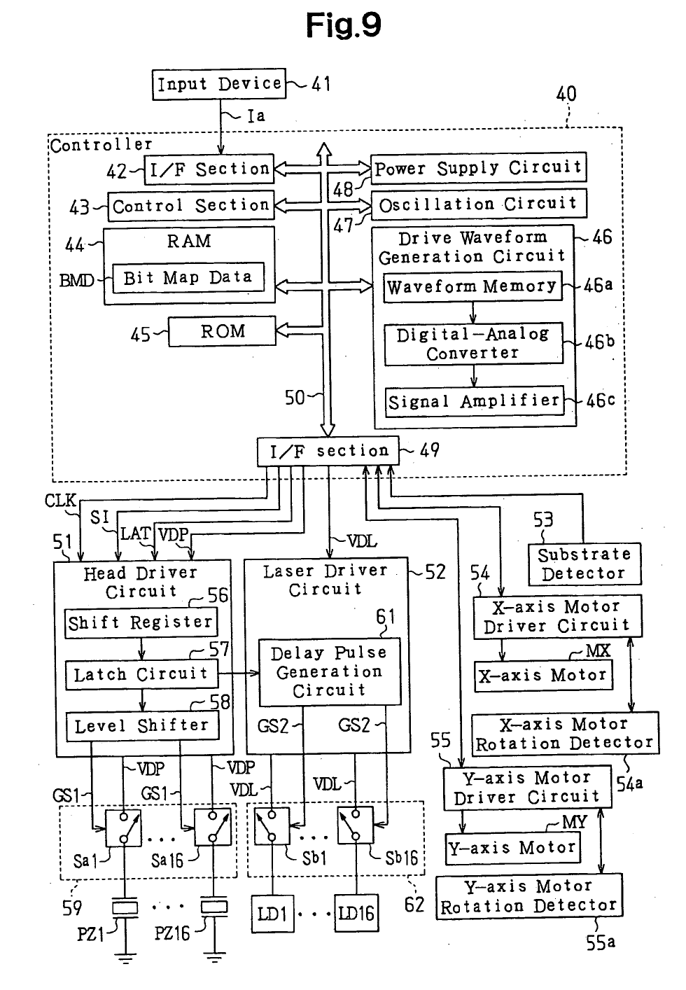

A pair of guide grooves 22 are defined in the upper surface of the base 21 and extend along the entire length of the base 21. A substrate stage 23 is secured to the upper surface of the base 21 and includes a linear movement mechanism (not shown), which is provided in correspondence with the guide grooves 22. The linear movement mechanism is formed by a threaded linear movement mechanism that includes threaded shafts (drive shafts) and ball nuts. The drive shafts extend in direction Y and along the guide grooves 22. The ball nuts are engaged with the threaded shafts. The drive shafts are connected to a y-axis motor MY (FIG. 9) formed by a stepping motor. In response to a drive signal corresponding to a predetermined number of steps that is input to the y-axis motor MY, the y-axis motor MY is rotated in a forward or reverse direction. This reciprocates the substrate stage 23 in direction Y at a predetermined speed (the scanning speed Vy) by an amount corresponding to the number of steps. The substrate stage 23, the y-axis motor MY, and the linear movement mechanism form transport means or a transport device.

In the illustrated embodiment, the substrate stage 23 reciprocates between a start position indicated by the corresponding solid lines of FIG. 5 and a return position indicated by the corresponding double-dotted broken lines of the drawing. As viewed in FIG. 5, the start position corresponds to a rightmost position and the return position corresponds to a leftmost position.

A mounting surface 24 is formed on the upper surface of the substrate stage 23. A non-illustrated suction type chuck mechanism is provided in the mounting surface 24. The substrate 2 is mounted on the mounting surface 24 with the backside 2b (the code formation area S) facing upward. The chuck mechanism thus positions and fixes the substrate 2 on the mounting surface 24 of the substrate stage 23. In this state, each of the columns of the cells C of the code formation area S extends in direction Y and each of the rows of the cells C extends in direction X. The first row of the cells C is located foremost in direction Y.

A pair of supports 25a, 25b are provided at opposing sides of the base 21. A guide member 26 extending in direction X is supported by the supports 25a, 25b. The length of the guide member 26 is greater than the width of the substrate stage 23 as measured along direction X. An end of the guide member 26 projects sideward with respect to the support 25a. A maintenance unit (not shown) for performing maintenance such as cleaning of an ejection head 30 is arranged immediately below the projecting end of the guide member 26.

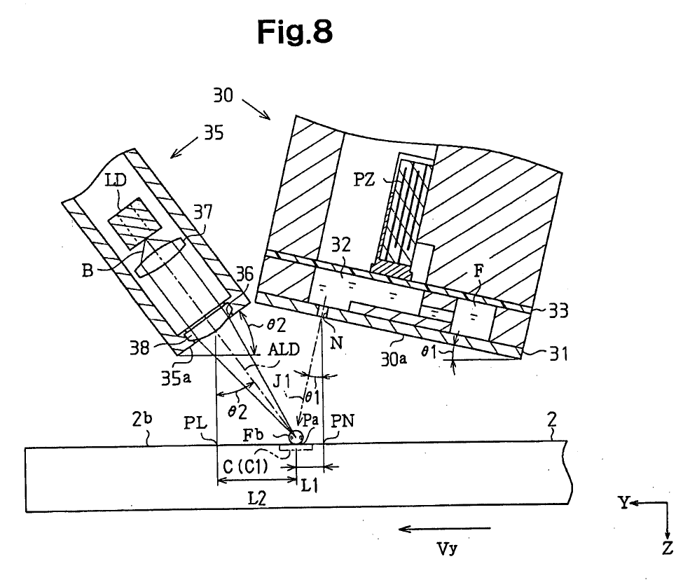

A reservoir 27 is arranged on the upper side of the guide member 26 and retains liquid F. The liquid F is introduced out of the reservoir 27, referring to FIG. 8. The liquid F is prepared by dispersing metal particles in a dispersion medium having affinity with the backside 2b of the substrate 2. A pair of, or upper and lower, guide rails 28 are formed in a lower portion of the guide member 26 and extend along the entire length of the guide member 26. A carriage 29 having a non-illustrated linear movement mechanism is secured to the guide rails 28. The linear movement mechanism is formed by a threaded type linear movement mechanism including a threaded shaft (a drive shaft) and a ball nut. The drive shaft extends along the guide rails 28 and along direction X. The ball nut is engaged with the drive shaft and fixed to the carriage 29. The drive shaft is connected to an x-axis motor MX (FIG. 9), which is rotated in a forward or reverse direction in a stepped-manner in response to a prescribed pulse signal. In other words, in response to a drive signal corresponding to a predetermined number of steps input to the x-axis motor MX, the x-axis motor MX is rotated in the forward or reverse direction. This reciprocates the carriage 29 in direction X by an amount corresponding to the number of steps.

As shown in FIG. 6, the ejection head 30 is formed on the lower surface of the carriage 29. FIG. 7 is a perspective view showing the ejection head 30 with a lower surface 30a of the ejection head 30 (opposed to the substrate stage 23) facing upward. FIG. 8 is a cross-sectional view showing a main portion of the ejection head 30 and represents the structure of the interior of the ejection head 30.

With reference to FIGS. 7 and 8, the ejection head 30 is formed in the carriage 29 as inclined at a predetermined angle (an ejection angle θ1). In this state, a rear end of the lower surface 30a of the ejection head 30 is more spaced from the substrate 2 than a front end of the lower surface 30a. A flat nozzle pale 31 is provided along the lower surface 30a of the ejection head 30. Sixteen nozzles N, each of which defines an ejection port for ejecting the microdroplet Fb, extend through the nozzle plate 31. The nozzles N are aligned in a single line as equally spaced in direction X (a direction defined by each row of the cells C). Each of the nozzles N is defined as a circular hole. The nozzles N are arranged at a pitch equal to the pitch at which the cells C are provided. Thus, when the substrate 2 (the code formation area S) is reciprocated in direction Y, the nozzles N oppose the corresponding row of the cells C. Referring to FIG. 8, each nozzle N extends perpendicular to the lower surface 30a. In other words, the axis of each nozzle N, or the extending direction of the nozzle N, is inclined at the ejection angle θ1 relative to a normal line (direction Z) of the substrate 2 (the surface 2a).

In the illustrated embodiment, the extending direction of each nozzle N, or the direction in which the nozzle N faces toward the substrate 2, is defined as an ejecting direction J1. Further, the positions of the backside 2b of the substrate 2 opposed to the nozzles N are defined as nozzle positions PN.

As shown in FIG. 8, cavities 32, or pressure chambers, are defined in the ejection head 30 at positions each opposed to one of the nozzles N. Each cavity 32 communicates with the reservoir 27 and thus sends the liquid F from the reservoir 27 to the corresponding one of the nozzles N. An oscillation plate 33 and a piezoelectric element PZ are arranged at the side of each cavity 32 opposed to the corresponding nozzle N. Each of the oscillation plates 33 oscillates in the ejecting direction J1 and a direction opposed to the ejecting direction J1. This selectively increases and decreases the volume of the corresponding cavity 32. Each of the piezoelectric elements PZ deforms in the ejecting direction J1 or the opposed direction and thus oscillates the associated oscillation plate 33.

If the ejection head 30 receives a signal (piezoelectric element drive voltage VDP) for driving any one of the piezoelectric element PZ, the corresponding piezoelectric element PZ is deformed so as to increase or decrease the volume of the associated cavity 32. The liquid F is thus ejected through the corresponding nozzle N by an amount corresponding to the reduced volume of the cavity 32. The liquid F then travels in the ejecting direction J1 as the microdroplet Fb and is received by the backside 2b of the substrate 2.

Since the ejection head 30 is inclined at the ejection angle θ1, the position at which the microdroplet Fb is received by the substrate 2 (a receiving position Pa) is located offset in direction Y with respect the nozzle position PN. In the illustrated embodiment, the offset amount of the receiving position Pa for the microdroplet Fb, which is determined by inclination of the ejection head 30 at the ejection angle θ1, is referred to as a first offset amount L1.

As the ejection head 30 is inclined at the ejection angle θ1, the traveling distance of each microdroplet Fb is increased correspondingly. Thus, in the illustrated embodiment, based on different test results, the ejection angle θ1 is set to a value that maintains accuracy of the position at which the microdroplet Fb is received by the substrate 2.

As shown in FIG. 6, a laser head 35 is formed along the lower surface of the carriage 29 and arranged behind the ejection head 30 (forward in direction Y). Referring to FIGS. 7 and 8, the laser head 35 is formed in the carriage 29 in a manner inclined at a predetermined angle (a radiating angle θ2). In this state, a front end of a lower surface 35a of the laser head 35 is more spaced from the substrate 2 than a rear end of the lower surface 35a. Sixteen radiation ports 36 are defined in the lower surface 35a of the laser head 35 in correspondence with the nozzles N. A semiconductor laser LD serving as laser radiation means or a laser radiation device is provided in the laser head 35 in correspondence with each of the radiation ports 36. Each of the semiconductor lasers LD receives a drive signal (laser drive voltage VDL) from a power supply circuit (FIG. 9). In response to the drive signal, each semiconductor laser LD radiates a laser beam B toward the radiation port 36. The laser beam B has a wavelength (for example, 800 nanometers) that dries the dispersion medium of the microdroplet Fb.

An optical system formed by a collimator 37 and a condenser lens 3B is provided between each of the semiconductor lasers LD and the associated radiation port 36. After having been radiated by the semiconductor laser LD, the laser beam B is converted into a parallel light flux by the collimator 37 and sent to the condenser lens 38. The condenser lens 38 condenses the laser beam B. In this manner, an optical axis ALD is formed by the laser head 35 through operation of each collimator 37 and that of the corresponding condenser lens 38. The optical axis ALD is inclined at the radiating angle θ2 with respect to direction Z.

As has been described, the laser head 35 (the optical axis ALD) is inclined at the radiating angle θ2. Thus, the position at which each laser beam B is received by the backside 2b (the radiating position) is located offset forward (or in the direction opposed to direction Y) from the position immediately below the corresponding condenser lens 38 (the laser position PL). In other words, the receiving position Pa is relatively brought closer to the radiating position by an amount corresponding to the inclination angle of the laser head 35, or the radiating angle θ2. In the illustrated embodiment, the offset amount of the radiating position determined by the radiating angle θ2 is referred to as a second offset amount L2.

That is, the radiating position is located offset in accordance with the second offset amount L2 and the receiving position is located offset in accordance with the first offset amount L1. The receiving position Pa of each microdroplet Fb thus coincides with the corresponding radiating position.

The laser head 35 radiates each laser beam B from behind the corresponding nozzle N., or from a position closer to the portion of the ejection head 30 (the nozzle plate 31) that is more spaced from the substrate 2. This decreases the radiating angle 32 compared to a case in which the laser beam B is radiated from the side from which the liquid F is ejected in the ejecting direction J1. In other words, the diameter of the laser beam B radiated onto each microdroplet Fb is prevented from becoming excessively large. The radiation accuracy of each laser beam B is thus maintained.

The electric configuration of the liquid ejection apparatus 20 will hereafter be described with reference to FIG. 9.

As shown in FIG. 9, a controller 40 includes a first interface (I/F) section 42, a control section 43, a RAM 44, and a ROM 45. The first I/F section 42 receives different types of data from an input device 41, which is, for example, an external computer. The control section 43 is formed by, for example, a CPU. The RAM 44 stores the data and the ROM 45 stores different control programs. The controller 40 also includes a drive waveform generation circuit 46, an oscillation circuit 47, a power supply circuit 48, and a second interface (I/F) section 49. The oscillation circuit 47 generates a clock signal CLK for synchronizing different drive signals. The power supply circuit 48 produces laser drive voltage VDL for driving each semiconductor laser LD. The second I/F section 49 transmits the drive signals. In the controller 40, the first I/F section 42, the control section 43, the RAM 44, the ROM 45, the waveform generation circuit 46, the oscillation circuit 47, the power supply circuit 48, and the second I/F section 49 are connected together through a bus 50.

The first I/F section 42 receives an image of the identification code 10 as a prescribed type of image data Ia. The identification code 10 is defined by a two-dimensional code that is obtained by a known method. The code represents identification data including the product number or the lot number of the substrate 2.

In correspondence with the image data Ia received by the first I/F section 42, the control section 43 performs an identification code formation procedure. More specifically, the control section 43 operates in accordance with control programs (for example, an identification code formation program) stored in the ROM 45 with the RAM 44 functioning as a processing region. That is, the control section 43 carries out a transport procedure for the substrate 2 by operating the substrate stage 23 and a liquid ejection procedure by driving each piezoelectric element PZ of the ejection head 30. Further, in accordance with the identification code formation program, the control section 43 executes a drying procedure for drying the microdroplets Fb by operating the semiconductor lasers LD.

More specifically, the control section 43 subjects the image data Ia, which has been received by the first I/F section 42, to prescribed development. This generates bit map data (BMD) instructing which ones of the cells C, which are defined in a two-dimensional imaging plane (the pattern formation area S), should receive the microdroplets Fb. The bit map data BMD is serial data having a bit length of 16×16 bits in correspondence with the piezoelectric elements PZ. With reference to the bit map data BMD, it is determined which ones of the piezoelectric elements PZ should be excited in accordance with the value of each bit (0 or 1).

The control section 43 further performs additional development, which is different than that for the bit map data BMD, on the image data Ia. This produces waveform data representing the piezoelectric drive voltage VDP, which is supplied to the piezoelectric elements PZ. The waveform data is then output to the drive waveform generation circuit 46. The drive waveform generation circuit 46 includes a waveform memory 46a, a digital-analog converter 46b, and a signal amplifier 46c. The waveform memory 46a stores the waveform data generated by the control section 43. The digital-analog converter 46b converts the waveform data into an analog signal and transmits the analog waveform signal. The analog waveform signal is then amplified by the signal amplifier 46c. In this manner, the drive waveform generation circuit 46 produces the piezoelectric drive voltage VDP for the piezoelectric elements PZ.

The control section 43 then serially transmits the bit map data BMD in a sequential manner as an ejection control signal SI to a head driver circuit 51 (a shift register 56) through the second I/F section 49. The ejection control signal SI is synchronized with the clock signal CLK of the oscillation circuit 47. Further, the control section 43 outputs a latch signal LAT to the head driver circuit 51 for latching the transmitted ejection control signal SI. Also, the control section 43 supplies the piezoelectric drive voltage VDP to the head driver circuit 51 (the switch elements Sa1 to Sa16) synchronously with the clock signal CLK of the oscillation circuit 47.

The head driver circuit 51, a laser driver circuit 52, a substrate detector 53, an x-axis motor driver circuit 54, and a y-axis motor driver circuit 55 are connected to the controller 40 through the second I/F section 49.

The head driver circuit 51 includes the shift register 56, a latch circuit 57, a level shifter 58, and a switch circuit 59. The shift register 56 converts the ejection control signal SI into a parallel signal of 16 bits in correspondence with the sixteen piezoelectric elements PZ (PZ1 to PZ16). As has been described, the ejection control signal SI is the serial signal that has been transmitted by the controller 40 (the control section 43) synchronously with the clock signal CLK. The latch circuit 57 then latches the parallel ejection control signal SI synchronously with the latch signal LAT, which is sent from the controller 40 (the control section 43). The latched ejection control signal SI is output to the level shifter 58 and the laser driver circuit 52.

The level shifter 58 raises the voltage of the latched ejection control signal SI to a level at which the switch circuit 59 is activated, thus generating an open-close signal GS1 corresponding to any one of the sixteen piezoelectric elements PZ. The switch circuit 59 includes switch elements Sa1 to Sa16 that are provided in correspondence with the piezoelectric elements PZ. The piezoelectric drive voltage VDP is commonly supplied to the inputs of the switch elements Sa1 to. Sa16. The output of each of the switch elements Sa1 to Sa16 is connected to the corresponding one of the piezoelectric elements PZ (PZ1 to PZ16). Each of the switch elements Sa1 to Sa16 receives a corresponding open-close signal GS1 from the level shifter 58. In correspondence with the open-close signal(s) GS1, the piezoelectric drive voltage. VDP is selectively supplied to the instructed one(s) of the piezoelectric elements PZ.

In other words, in the liquid ejection apparatus 20 of the illustrated embodiment, the drive waveform generation circuit 46 generates the piezoelectric drive voltage VDP. The piezoelectric drive voltage VDP is then supplied commonly to the instructed piezoelectric elements PZ through the corresponding switch elements Sa1 to Sa16. The activation of each switch element Sa1 to Sa16 is controlled in correspondence with the ejection control signal SI (the open-close signal GS1), which is generated by the controller 40 (the control section 43). When any one of the switch elements Sa1 to Sa16 is closed, the piezoelectric drive voltage VDP is supplied to the corresponding piezoelectric element PZ1 to PZ16, thus causing ejection of the microdroplet Fb through the corresponding nozzle N.

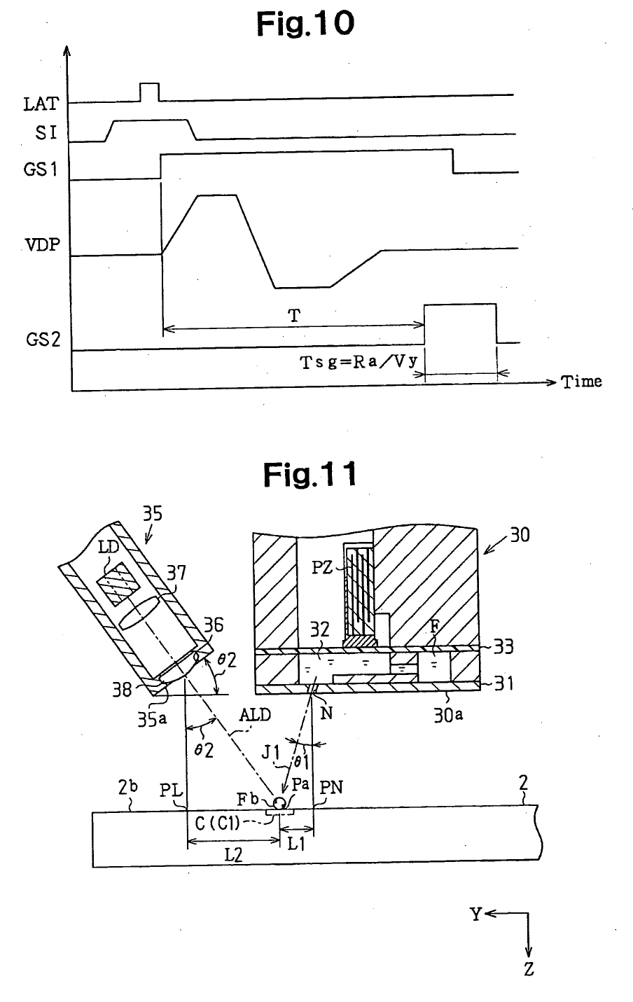

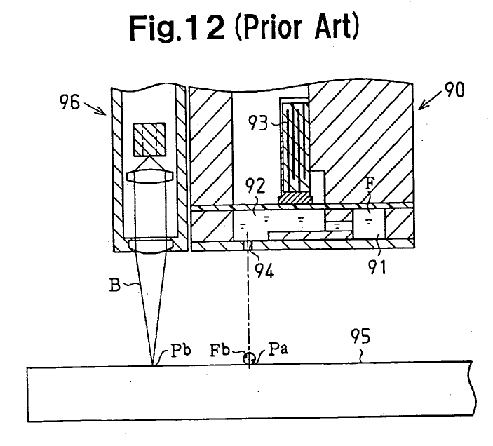

FIG. 10 is a timing chart representing the pulse waveforms of the ejection control signal SI and the open-close signal GS1 and the waveform of the piezoelectric drive voltage VDP, which is supplied to the piezoelectric element (s) PZ in response to the corresponding open-close signal(s) GS1.

Referring to FIG. 10, when the latch signal LAT, which is input to the head driver circuit 51, is turned off, the open-close signal GS1 is generated in correspondence with the ejection control signal SI of 16 bits. When the open-close signal GS1 is turned on, the piezoelectric drive voltage VDP is supplied to the corresponding piezoelectric element PZ. As the piezoelectric drive voltage VDP increases, the piezoelectric element PZ contracts. This introduces the liquid F into the corresponding cavity 32. As the piezoelectric drive voltage VDP decreases, the piezoelectric element PZ extends. The liquid F is thus introduced out from the cavity 32 and ejected as the microdroplet Fb. When such ejection is completed, the piezoelectric drive voltage VDP restores the initial value. In this manner, the ejection of the microdroplet Fb through excitement of the corresponding piezoelectric element PZ is ended.

As shown in FIG. 9, the laser driver circuit 52 includes a delay pulse generation circuit 61 and a switch circuit 62. The delay pulse generation circuit 61 generates a pulse signal (an open-close signal GS2) by delaying the ejection control signal SI that has been latched by the latch circuit 57 by an amount corresponding to a predetermined time (standby time T). The open-close signal GS2 is then input to the switch circuit 62.

In the illustrated embodiment, the standby time T is defined as a value that has been obtained in tests. More specifically, the standby time T is defined as the time from when the liquid ejection through excitement of the piezoelectric elements PZ is started, or when supply of the piezoelectric drive voltage VDP is started, to when the microdroplets Fb are received by the substrate 2.

The switch circuit 62 includes switch elements Sb1 to Sb16 that are provided in correspondence with the semiconductor lasers LD. The laser drive voltage VDL, which is generated by the power supply circuit 48, is supplied commonly to the inputs of the switch elements Sb1 to Sb16. The output of each switch element Sb1 to Sb16 is connected to the corresponding one of the semiconductor lasers LD (LD1 to LD16). Each switch element Sb1 to SB16 receives the corresponding open-close signal GS2 from the delay pulse generation circuit 61. Supply of the laser drive voltage VDL to each of the semiconductor lasers LD is controlled in correspondence with the corresponding open-close signal GS2.

More specifically, in the liquid ejection apparatus 20 of the illustrated embodiment, the power supply circuit 48 generates the laser drive voltage VDL. The laser drive voltage VDL is supplied commonly to the instructed semiconductor lasers LD through the corresponding switch elements Sb1 to Sb16. Operation of each switch element Sb1 to Sb16 is controlled in correspondence with the corresponding ejection control signal SI (open-close signal GS2), which is generated by the controller 40 (the control section 43). When any one of the switch elements Sb1 to Sb16 is closed, the laser drive voltage VDL is supplied to the corresponding semiconductor laser LD1 to LD16, thus causing radiation of the laser beam B from the semiconductor laser LD.

In the illustrated embodiment, the pulse-time width of the open-close signal GS2, which is generated by the delay pulse generation circuit 61, is set to a value equal to the time in which one of the cells C passes through the optical axis ALD of the laser beam B (pulse-time width Tsg=Ra/Vy). However, the pulse-time width of the open-close signal GS2 may be defined in any other suitable manners as needed.

Following inputting of the latch signal LAT to the head driver circuit 51, with reference to FIG. 10, the open-close signal GS2 is generated after the standby time T has passed. When the open-close signal GS2 is turned on, the laser drive voltage VDL is supplied to the instructed semiconductor laser LD, causing the semiconductor laser LD to radiate the laser beam B. The open-close signal GS2 is turned off immediately after the corresponding cell C has passed through the beam spot (the pulse width Tsg has passed). This stops the supply of the laser drive voltage VDL, thus ending a drying procedure by the semiconductor laser LD.

The substrate detector 53 is connected to the controller 40 through the second I/F section 49. The substrate detector 53 detects an end of the substrate 2. In correspondence with detection of the substrate detector 53, the controller 40 calculates the position of the substrate 2 that is passing immediately below the ejection head 30 (the nozzles N).

The x-axis motor driver circuit 54 is connected to the controller 40 through the second I/F section 49. The controller 40 sends a drive signal to the x-axis motor driver circuit 54. In response to the drive signal of the controller 40, the x-axis motor driver circuit 54 operates the x-axis motor MX, which drives the carriage 29, to rotate in a forward or reverse direction. When the x-axis motor MX rotates in the forward direction, the carriage 29 is moved in direction X. When the x-axis motor MX rotates in the reverse direction, the carriage 29 is moved in a direction opposed to direction X.

An x-axis motor rotation detector 54a is connected to the controller 40 through the x-axis motor driver circuit 54. The controller 40 thus receives a detection signal from the x-axis motor rotation detector 54a. In correspondence with the detection signal, the controller 40 detects the rotational direction and the rotation amount of the x-axis motor MX and thus the movement amount in direction X and the movement direction of the ejection head 30 (the carriage 29).

The y-axis motor driver circuit 55 is connected to the controller 40 through the second I/F section 49. The controller 40 thus sends a drive signal to the y-axis motor driver circuit 55. In response to the drive signal of the controller 40, the y-axis motor driver circuit 55 operates the y-axis motor MY, which drives the substrate stage 23, to rotate in a forward or reverse direction. This moves the substrate stage 23 at the scanning speed Vy. When the y-axis motor MY is rotated in the forward direction, the substrate stage 23 (the substrate 2) is moved in direction Y at the scanning direction Vy. When the y-axis motor MY is rotated in the reverse direction, the substrate stage 23 (the substrate 2) is moved in a direction opposed to direction Y at the scanning direction Vy.

A y-axis motor rotation detector 55a is connected to the controller 40 through the y-axis motor driver circuit 55. The y-axis motor rotation detector 55a generates a detection signal and sends the signal to the controller 4C. In correspondence with the detection signal of the y-axis motor rotation detector 55a, the controller 40 detects the rotational direction and the rotation amount of the y-axis motor MY and calculates the movement direction and the movement amount of the substrate 2 relative to the ejection head 30.

A method for forming the identification code 10 on the backside 2b of the substrate 2 using the liquid ejection apparatus 20 will be explained in the following.

First, referring to FIG. 5, the substrate 2 is fixed to the substrate stage 23, which is arranged at the start position, with the backside 2b facing upward. In this state, referring to FIG. 6, a rear end of the substrate 2 is located immediately before a front end of the guide member 26. Further, the ejection head 30 formed in the carriage 29 is set in such a manner that the code formation area S for the identification code 10 passes immediately below the carriage 29 when the substrate 2 moves in direction Y.

At this stage, the controller 40 drives the y-axis motor MY to operate the substrate stage 23. The substrate stage 23 thus transports the substrate 2 in direction Y at the scanning speed Vy. When the substrate detector 53 detects the rear end of the substrate 2, the controller 40 determines whether the first row of the cell C (the black cells C1) has reached the receiving positions Pa in correspondence with a detection signal generated by the y-axis motor rotation detector 55a.

Meanwhile, in correspondence with the identification code formation program, the controller 40 transmits the ejection control signal SI and supplies the piezoelectric drive voltage VDP to the head driver circuit 51. The ejection control signal SI is produced in correspondence with the bit map data BMP, which is stored in the RAM 44. The piezoelectric drive voltage VDP is generated by the drive waveform generation circuit 46. Also, the controller 40 supplies the laser drive voltage VDL, which is generated by the power supply circuit 48, to the laser driver circuit 52. Then, the controller 40 stands by until the latch signal LAT must be output.

When the first row of the cells C (the black cells C1) reaches-the receiving positions Pa, the controller 40 sends the latch signal LAT to the head driver circuit 51. In response to the latch signal LAT, the head driver circuit 51 generates the open-close signal GS1 in correspondence with the ejection control signal SI. The open-close signal GS1 is sent to the switch circuit 59. The piezoelectric drive voltage VDP is thus supplied to the piezoelectric element PZ corresponding to each switch element Sa1 to Sa16 that is held in a closed state. The microdroplets Fb, which are produced in correspondence with the piezoelectric drive voltage VDP, are thus simultaneously ejected from the corresponding nozzles N in the ejecting directions J1. In this manner, after the standby time T has elapsed following reception of the latch signal LAT, each of the microdroplets Fb reaches the corresponding receiving position Pa, which is located offset from the corresponding nozzle position PN in direction Y by the first offset amount L1.

Meanwhile, when the head driver circuit 51 receives the latch signal LAT, the laser driver circuit 52 (the delay pulse generation circuit 61) generates the open-close signal GS2 in response to the ejection control signal SI that has been latched by the latch circuit 57. Immediately after the standby time T has elapsed, the open-close signal GS2 is output to the switch circuit 62. This supplies the laser drive voltage VDL to the semiconductor lasers LD corresponding to the switch elements Sb1 to Sb16 that are held in the closed states. Accordingly, with the microdroplets Fb provided at the receiving positions Pa, the semiconductor lasers LD simultaneously radiate the laser beams B to the corresponding receiving positions Pa, each of which is located offset from the corresponding laser position PL in the direction opposed to direction Y. Radiation of the laser beams B lasts for the time corresponding to the pulse width Tsg.

In other words, the microdroplets Fb are simultaneously ejected onto the black cells C1 of the first row. When received by the substrate 2, the microdroplets Fb are irradiated with the laser beams B, which are radiated by the corresponding semiconductor lasers LD. This causes evaporation of the dispersion medium of each microdroplet Fb and dries the microdroplet Fb. The microdroplets Fb are thus fixed to the backside 2b of the substrate 2. That is, the microdroplets Fb are prevented from spreading wet beyond the corresponding cells C (black cells C1). Accordingly, the dots D of the first row are provided as contained in the corresponding cells C (black cells C1).

Afterwards, the controller 40 continuously operates to move the substrate 2 at the scanning speed Vy. When each row of the cells C reaches the receiving positions Pa, the microdroplets Fb are simultaneously ejected onto the corresponding black cells C1 by the nozzles N. The laser beams B are simultaneously radiated onto the microdroplets Fb when the microdroplets Fb are located at the receiving positions Pa.

When all the dots of the identification code 10 are completely formed, the controller 40 operates the y-axis motor MY to retreat the substrate 2 from the position below the ejection head 30.

The illustrate embodiment has the following advantages.

(1) In the illustrated embodiment, the ejection head 30 is formed in the carriage 29 as inclined at the ejection angle θ1. This causes each microdroplet Fb to travel in the ejecting direction J1 that is inclined at the ejection angle θ1 with respect to the normal line (direction Z) of the substrate 2 (the surface 2a). Further, the receiving position Pa at which the microdroplet Fb is received by the backside 2b is located offset toward the corresponding radiating position of the laser beam B by the first offset amount L1.

In this manner, the timing for radiating the laser beam B onto each microdroplet Fb received by the substrate 2 is advanced by an amount corresponding to the first offset amount L1 of the receiving position Pa. This suppresses overflowing of the microdroplet Fb from the corresponding cell C.

(2) In the illustrated embodiment, the laser head 35 is formed in the carriage 29 as inclined at the radiation angle θ2. This inclines the optical axis ALD of each laser beam B by an amount corresponding to the radiation angle θ2 with respect to the normal line (direction Z) of the substrate 2 (the surface 2a). Further, the radiating position of the laser beam B is located offset from the corresponding laser position PL toward the receiving position Pa by the second offset amount L2.

In this manner, the receiving position Pa for each microdroplet Fb is brought closer to the corresponding radiating position by an amount corresponding to the second offset amount L2 of the radiating position. Accordingly, the timing for radiating the laser beam B onto each of the microdroplets Fb is further advanced, allowing the microdroplets Fb to quickly dry. This suppresses overflowing of the microdroplets Fb from the corresponding cells C (black cells C1). The dots D are thus provided as contained in the corresponding cells C (black cells C1).

(3) The laser head 35 radiates the laser beams B from the side opposed to the nozzles N with respect to the receiving positions Pa, or from a position close to the portion of the ejection head 30 (the nozzle plate 31) more spaced from the substrate 2.

Thus, compared to the case in which the laser beams B are radiated from the side corresponding to the nozzles N with respect to the receiving positions Pa, the radiation angle θ2 can be reduced. This prevents the diameter of the laser beam B that is radiated onto each microdroplet Fb on the substrate 2 from becoming excessively large. The radiation accuracy of the laser beam B is thus maintained.

(4) In the illustrated embodiment, the ejection angle θ1 and the radiation angle θ2 are selected in such a manner that each radiating position coincides with the corresponding receiving position Pa.

Thus, the laser beam B is radiated onto each microdroplet Fb when the microdroplet Fb is received by the substrate 2. This maximally shortens the time in which spreading of the microdroplet Fb lasts.

(5) In the illustrated embodiment, the open-close signal GS1 for starting the liquid ejection through excitement of the piezoelectric elements PZ is generated when the latch signal LAT produced by the controller 40 is turned off. Immediately after the standby time T has elapsed Following generation of the open-close signal GS1, the open-close signal GS2 for starting radiation of the laser beams B is turned on. That is, radiation of the laser beams B is reliably started immediately after the standby time T has elapsed following starting of the ejection of the microdroplets Fb.

Thus, the radiation of the laser beams B is reliably performed in correspondence with reception of the microdroplets Fb by the substrate 2. In this manner, the dots D are reliably provided as contained in the corresponding cells C (black cells C1).

The illustrated embodiment may be modified as follows.

In the illustrated embodiment, the ejection head 30 is inclined at the ejection angle θ1 with respect to the carriage 29. However, referring to FIG. 11, the lower surface 30a of the ejection head 30 may be arranged parallel with the backside 2b of the substrate 2. In this case, only the line of each nozzle N is inclined at the ejection angle θ1 with respect to the normal line of the substrate 2. Alternatively, the carriage 29 may be inclined at the ejection angle θ1. Also in these cases, the advantages of the illustrated embodiments are ensured.

In the illustrated embodiment, the optical axis ALD of each laser beam B is inclined at the radiation angle θ2. However, the optical axis ALD may be arranged parallel with the normal line of the substrate 2 (the surface 2a). In this case, advancement of the timing for radiating the laser beams B is brought about only by the inclination of the ejection head 30 at ejection angle θ1.

In the illustrated embodiment, the ejection angle θ1 and the radiation angle θ2 are selected in such a manner that each radiating position coincides with the corresponding receiving position Pa. However, the ejection angle θ1 and the radiation angle θ2 may be set in such a manner that the radiating position is spaced from the receiving position Pa. In this case, the scanning speed Vy of the substrate stage 23 must be increased so as to shorten the transport time of each microdroplet Fb from the receiving position Pa to the radiating position. This cancels delay of the timing for radiating the laser beams B caused by spacing between the radiating position and the receiving position Pa.

In the illustrated embodiment, the microdroplets Fb having affinity to the backside 2b of the substrate 2 are used. However, instead of this, a substrate that sheds the microdroplets Fb may be employed as the substrate 2.

In this case, each microdroplet Fb gradually deforms on the substrate 2 into a spherical shape due to the repellency of the substrate 2 with respect to the liquid F. Nonetheless, the corresponding dot D is reliably formed to a desired size.

In the illustrated embodiment, each microdroplet Fb is ejected onto the substrate 2 and is allowed to spread on the substrate 2 in a wet state. In this state, the laser beam B is radiated onto the microdroplet Fb for forming the dot D. However, the microdroplet Fb may be ejected onto a porous substrate (for example, a ceramic multi-layered substrate or a green sheet) and allowed to permeate through the substrate. In this state, a pattern of metal wiring can be formed by radiating the laser beam B onto the microdroplet Fb.

The radiation of the laser beam B reduces permeation of the microdroplet Fb through the substrate in such a manner as to form the metal wiring of the desired size.

In the illustrated embodiment, the open-close signal GS2 is generated in correspondence with the ejection control signal SI. However, the open-close signal S2 may be generated in correspondence with the detection signal of the substrate detector 53 or the y-axis motor rotation detector 55a. That is, generation of the open-close signal GS2 may be performed in any other suitable manners, as long as radiation of the laser beam B onto each microdroplet Fb held at the radiating position is permitted.

In the illustrated embodiment, each radiating position of the laser beam B is fixed. However, an optical scanning system such as a polygon mirror may be provided in the laser head 35. The radiating position of the laser beam B is thus movable in correspondence with movement of the corresponding microdroplet Fb. That is, the laser beam B is moved from the receiving position Pa along direction Y, together with the microdroplet Fb.

This prolongs the time for radiating the laser beam B by an amount corresponding to the movement of the laser beam B. The microdroplets Fb are thus assuredly dried and the outer diameter of each dot D is reliably adjusted.

In the illustrated embodiment, the laser radiation means is defined by the semiconductor lasers LD. However, the laser radiation means may be formed by any other suitable means such as CO₂ lasers or YAG lasers, as long as the laser beams B radiated by such means each have a wavelength that permits the microdroplets Fb to dry on the substrate 2.

In the illustrated embodiment, the semiconductor lasers LD are provided by the quantity corresponding to that of the nozzles N. However, an optical system that radiates a single laser beam B from a laser source may be employed. In this case, the optical system divides the laser beam B into sixteen rays using a dividing element such as a diffracting element.

In the illustrated embodiment, radiation of the laser beams B is controlled in correspondence with the operational states of the switch elements Sb1 to Sb16 corresponding to the semiconductor lasers LD. However, a shutter that can be selectively opened and closed may be provided on the optical path of each laser beam B. The radiation of the laser beam B is thus controlled in correspondence with the operational timings of the shutter.

In the illustrated embodiment, the dots D are formed by drying the microdroplets Fb. However, insulating films or metal wirings may be formed through such drying of the microdroplets Fb. Also in these cases, the sizes of the insulating films or the metal wirings may be adjusted in desired manners.

In the illustrated embodiment, the transparent glass substrate is used as the substrate 2. However, the substrate 2 may be formed by a silicone substrate or a flexible substrate or a metal substrate.

In the illustrated embodiment, the microdroplets Fb are ejected through excitement of the piezoelectric elements PZ. However, such ejection may be caused by any other suitable methods that do not involve the piezoelectric elements PZ. For example, the cavities 32 may be pressurized by generating and bursting bubbles in the cavities 32 so as to eject the microdroplets Fb.

In the illustrated embodiment, the present invention is applied to the liquid ejection apparatus 20 that forms the dots D. However, the present invention may be applied to a liquid ejection apparatus that forms the insulating films or the metal wirings. Also in these cases, the dots of the desired sizes can be obtained.

In the illustrated embodiment, the dots D are (the identification code 10 is) formed in the liquid crystal display module 1. However, the dots D may be provided in, for example, a display module of an organic electroluminescence display or a display module having a field effect device (an FED or an SED). The field effect device includes a flat electron emission element and emits light from a fluorescent substance using electrons that are emitted by the flat electron emission element.

The present examples and embodiments are to be considered as illustrative and not restrictive, and the invention is not to be limited to the details given herein, but may be modified within the scope and equivalence of the appended claims.

1. A liquid ejection apparatus comprising:
an ejection head having an ejection port through which a liquid droplet containing a dot forming material is ejected onto a substrate; and
a laser radiation device that radiates a laser beam for drying the liquid droplet on the substrate and thus forming a dot from the dot forming material,
wherein the ejection head is oriented in such a manner that the liquid droplet is ejected from the ejection port to a radiating position of the laser beam defined on the substrate.

2. The apparatus according to claim 1, wherein the ejection head is inclined with respect to a normal line of the substrate.

3. The apparatus according to claim 1, wherein the ejection port has a line that is inclined toward the radiating position with respect to the normal line of the substrate.

4. The apparatus according to claim 1 further comprising a transport device that transports the liquid droplet that has been received by the substrate to the radiating position of the laser beam.

5. The apparatus according to claim 1, wherein the ejection head ejects the liquid droplet from a position located rearward in a transport direction of the substrate, and
wherein the laser radiation device radiates the laser beam from a position located forward in the transport direction of the substrate.

6. The apparatus according to claim 1, wherein the laser radiation device is formed by a semiconductor laser.

7. An identification code formation apparatus for forming a dot-matrix identification code on a substrate, the apparatus comprising:
an ejection head having a plurality of ejection ports aligned in a direction X, each of the ejection ports ejecting a liquid droplet containing dot forming material onto the substrate;
a laser radiation device that radiates a laser beam onto each of the liquid droplets received by the substrate so as to dry the liquid droplet and thus form a dot from the dot forming material;
a transport device that transports the substrate in a direction Y crossing the direction in which the ejection ports are aligned; and
a controller that controls the ejection head, the laser radiation device, and the transport device in such a manner as to sequentially perform ejection of the liquid droplets, radiation of the laser beams, and transport of the substrate,
wherein the ejection head is oriented in such a manner that each of the liquid droplets is ejected from the corresponding ejection port toward a radiating position of the laser beam defined on the substrate.

8. The apparatus according to claim 7 further comprising a carriage movable in the direction X, wherein the ejection head is supported by the carriage.

9. The apparatus according to claim 7, wherein the ejection head is inclined with respect to a normal line of the substrate.

10. The apparatus according to claim 7, wherein each of the ejection ports includes a line inclined toward the radiating position with respect to the normal line of the substrate.

11. The apparatus according to claim 7, wherein the ejection head ejects the liquid droplets from positions located rearward in a transport direction of the substrate, and
wherein the laser radiation device radiates the laser beams from positions forward in the transport direction of the substrate.

12. The apparatus according to claim 7, wherein the laser radiation device is formed by a semiconductor laser.
